(19) United States
(12) Patent Application Publication
(10) Pub. No.: US 2022/0202528 A1
(43) Pub. Date: Jun. 30, 2022

(54) SYSTEM AND METHOD FOR ENGAGING BEAKS AND MIXING TIPS

(71) Applicants: Edward Barton Coffey, Rancho Santa Fe, CA (US); Barbara Campbell, San Diego, CA (US); Olivia A. Wheeler, Encinitas, CA (US)

(72) Inventors: Edward Barton Coffey, Rancho Santa Fe, CA (US); Barbara Campbell, San Diego, CA (US); Olivia A. Wheeler, Encinitas, CA (US)

(21) Appl. No.: 17/136,990

(22) Filed: Dec. 29, 2020

(51) Int. Cl. A61C 5/64; B05C 17/005; A61C 9/00; B05C 17/01

(52) U.S. Cl. CPC A61C 5/64; B05C 17/00593; B05C 17/00506; B05C 17/0133; A61C 9/0026

(57) ABSTRACT

A device is provided for assembling components of a mixing syringe for use in a dental procedure. For this assembly, the components of interest include a beak and a mixing tip for the syringe. Specifically, the device includes a top plate formed with a hole, and a support member for the top plate that maintains the hole at a predetermined height H above a surface when the device is placed on the surface. For an assembly operation, the beak is supported on the device with a portion of the beak inserted downwardly through the hole of the top plate. This also extends a gripping member of the beak upwardly above the top plate. A grab ring of the mixing tip is then pushed against the gripping member of the beak for their engagement with each other. They are then removed together from the device and engaged with the mixing syringe.

### FIELD OF THE INVENTION

The present invention pertains to dental syringes. More particularly, the present invention pertains to dental syringes that combine two different constituents into a composite material for making dental impressions or plastic build-ups. The present invention is particularly, but not exclusively, useful as a system and method for assembling a dental syringe with properly dimensioned components for a patient-specific application.

### BACKGROUND OF THE INVENTION

Mixing syringes which are used by dentists, for such procedures as preparing dental impressions and constructing build-ups, have typically required the use of disposable components. This happens because of the consequences that result when mixing different materials for these purposes. Namely, unlike the original semi-fluid materials that are to be mixed with each other, the resultant material is a composite that will typically solidify within a short period of time. Because some of the mixed materials remain in the components of the mixing syringe after its use, these components are typically discarded.

The assembly of a mixing syringe for the purposes mentioned above, has, however, heretofore presented some difficulties. Specifically, there are two components of the mixing syringe, that will be subsequently discarded. It happens that these components are particularly difficult to be interconnected. Specifically, these components are a mixing tip, which mixes the constituent materials, and a so-called beak which directs the mixed components to its intended destination in the mouth of a patient.

In practice, the process of connecting a beak with a mixing tip has proven to be problematic in the clinical environment, i.e. the dentist's office. Specifically, these components are relatively small and their interconnection with each other must be essentially fluid-tight. Moreover, as a practical matter, it is also important to have an ability to separately select individual beaks and mixing tips of different sizes and shapes for their use in a particular procedure. Moreover, it is necessary to perform the task of connecting beaks and mixing tips with minimal difficulty and risk of injury.

For the reasons presented above, it is an object of the present invention to provide an assembly device for easily, conveniently, and effectively joining a beak to a mixing tip. Another object of the present invention is to provide the combination of a beak with mixing tip that can be further interconnected with a syringe body for dental protocol. Still another object of the present invention is to provide a system and method for the assembly of a mixing syringe that is simple to construct, is easy to use, and is cost effective.

### SUMMARY OF THE INVENTION

In accordance with the present invention a device is provided for assembling a mixing syringe that will be used for dental procedures. Specifically, the mixing syringe is of a type, well known in the pertinent art, that mixes two different semi-fluid constituents which interact with each other to create solid dental impressions and/or plastic build-ups. Because the mixed constituents become solid, the interactive components of an operational mixing syringe that mix these constituents can be typically used only once, and they must then be discarded. Consequently, they are typically assembled on-site at the dentist's office before each procedure.

Structurally, the assembly device of the present invention includes a circular top plate which is formed with a hole through the top plate that has a diameter D. A support member is engaged with the perimeter of the top plate to maintain the hole through the top plate at a predetermined height H above the surface on which the support member of the assembly device is positioned. Once the assembly device is positioned, it is be specifically used to interconnect a beak with a mixing tip. The combination of beak and mixing tip can then be joined with a syringe body to establish the mixing syringe.

The beak component of a mixing syringe has a proximal end and a distal end, and it includes, in combination, a distal tapered tube and a proximal gripping member. The beak is formed with a lumen that extends through its entire length in both the gripping member and the tapered tube. Further, the tapered tube has a decreasing outer diameter in the distal direction that starts from a diameter d near the gripping member at the proximal end of the tube. Importantly, the diameter d of the tube at its proximal end must be smaller than the diameter D of the hole in the top plate of the assembly device. This allows for an insertion of the tapered tube through the hole of the top plate.

In detail, the gripping member of the beak includes a ledge having an outer diameter Dₒ that extends radially outwardly from the lumen of the beak at the proximal end of the tapered tube. Importantly, the diameter d of the beak's tube is less than the diameter D of the hole in the top plate. In turn, the diameter D of the hole is less than the diameter D) of the ledge. Thus, the tapered tube of the beak can be extended through the hole in the top plate to support the gripping member of the beak above the top plate with the gripping member extending upwardly and away from the top plate.

In addition to the ledge, the gripping member of the beak also includes a beveled grip at its proximal end of the beak which is formed with a projection that extends radially outwardly from the lumen of the gripping member. With this structure, an annular recess is formed on the gripping member between the ledge and the projection of the beveled grip. As intended for the present invention, when it is positioned on the assembly device, the gripping member of the beak is properly oriented for engagement with another component of the mixing syringe; namely, the mixing tip.

For purposes of the present invention, the mixing tip structurally includes a straight elongated tube that surrounds a mixing chamber and extends between a proximal end and a distal end of the mixing chamber. A mixing screw is positioned in the chamber of the tube for mixing different constituents as they are pushed through the chamber by the mixing syringe. Also, the mixing tip includes a circular grab ring which is formed at its distal end to extend radially inwardly toward the axis of the mixing chamber. Importantly, this grab ring is dimensioned to be received into the annular recess of the gripping member. Thus, the straight tube of the mixing tip is held in fluid communication with the tapered tube of the beak.

Once the mixing tip is engaged with the beak, the combination can be withdrawn from the assembly device and connected with the syringe body of the mixing syringe. Typically, a syringe body that is used for the present invention will have a first cylinder containing a first material and a second cylinder containing a second material. When the connector of the mixing tip is engaged with the syringe body, the first cylinder and the second cylinder are connected in fluid communication with the elongated tube of the mixing tip. A plunger that is mounted on the syringe body can then be activated to simultaneously push the first and second materials respectively from the first and second cylinders and into the mixing chamber of the straight elongated tube. In the mixing chamber the mixing screw acts to combine the first and second materials into a composite material for extrusion from the mixing tip and through the beak for its intended purpose.

As intended for the present invention, the beak is made of a semi-deformable elastomer. On the other hand, the mixing tube of the mixing tip is preferably made of a relatively rigid elastomer when compared with the beak. As noted above, the beak and mixing tip, in combination, are disposable after use.

For an operation of the present invention, the assembly device is positioned on a substantially horizontal surface to maintain the hole of the top plate at a predetermined height H above the surface. The tapered tube portion of the beak, which is shorter than H, is then inserted downwardly through the hole in the top plate. This insertion leaves the gripping member of the beak extending upwardly and away from the top plate. The mixing tip is then pushed downwardly against the gripping member of the beak. This action engages the grab ring of the mixing tip with the annular recess in the gripping member of the beak. This combination of mixing tip and beak is then removed from the assembly device for attachment to the syringe body of the mixing syringe.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is an exploded perspective view of the essential components involved for an assembly operation of a mixing syringe in accordance with the present invention showing, sequentially, an assembly device, a beak, a mixing tip, and a syringe body (shown representatively);

FIG. 2 shows an engagement of the beak on the assembly device with portions broken away for clarity, and with a distal portion of the mixing tip positioned for engagement with the beak;

FIG. 3 shows assembled components for the mixing syringe ready to be lifted from the assembly device for functional use with a syringe body in a dental procedure;

FIG. 4 is a cross section view of the beak as seen along the line 4-4 in FIG. 1; and

FIG. 5 is a cross section view of the beak in combination with the distal end of the mixing tip as would be seen along the line 5/4-5/4 in FIG. 1.

### DESCRIPTION OF THE PREFERRED EMBODIMENTS

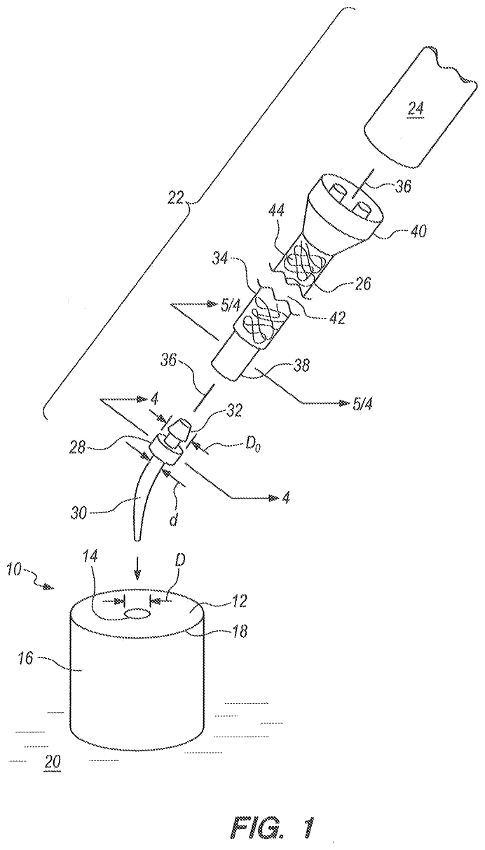

Referring initially to FIG. 1, an assembly device in accordance with the present invention is shown and is generally designated 10. As shown in FIG. 1 the assembly device 10 includes a top plate 12 that is formed with a through hole 14. Also shown in FIG. 1 is a support member 16 that is connected to the top plate 12 of the assembly device 10 at the perimeter 18 of the top plate 12. As intended for the present invention, and as shown in FIG. 1, the assembly device 10 is to be operationally positioned on a surface 20.

Still referring to FIG. 1, it is to be appreciated that a mixing syringe 22 is to be assembled in accordance with the present invention. In detail, the mixing syringe 22 will include a syringe body 24, a mixing tip 26 and a beak 28. As noted above, the mixing tip 26 and the beak 28 are typically provided as separate components of the mixing syringe 22 and are preferably assembled on-site at the location where the mixing syringe 22 is to be used.

FIG. 1 also shows that a tapered tube 30 constitutes a distal portion of the beak 28, and a gripping member 32 constitutes a proximal portion of the beak 28. Further, FIG. 1 shows the mixing tip 26 includes a straight tube 34 that defines an axis 36. As shown, the straight tube 34 has a distal end 38, with a connector 40 attached at its opposite end. A mixing chamber 42 extends along the axis 36 between the distal end 38 and the connector 40 and has a mixing screw 44 for mixing separate materials as they are pushed from the syringe body 24 through the mixing chamber 42.

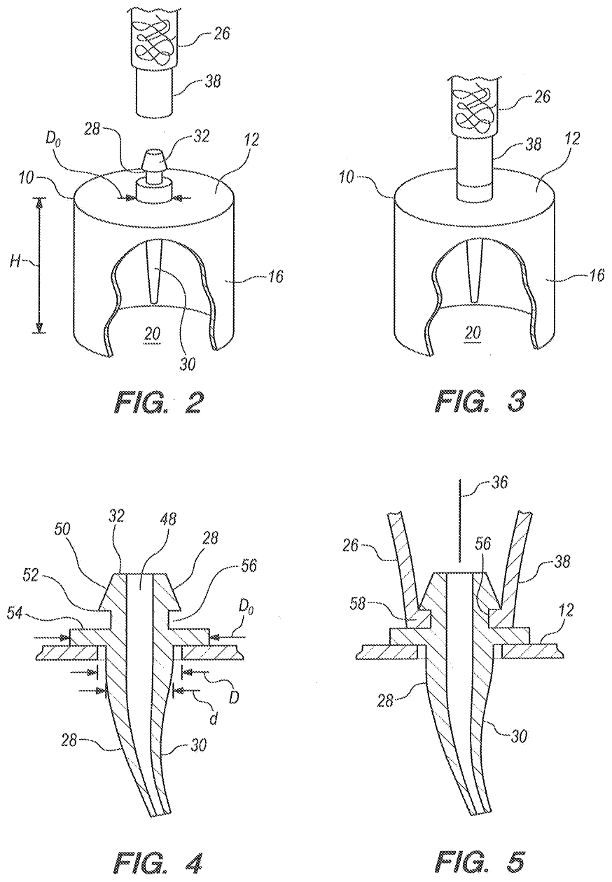

Referring to FIGS. 2 and 3, in sequence, it can be appreciated that, with the beak 28 positioned on the assembly device 10 where its tapered tube 30 is surrounded by the support member 16 (FIG. 2), the distal end 38 of the mixing tip 26 can be pushed down onto gripping member 32 of the beak 28 (FIG. 3), to engage the mixing tip 26 with the beak 28. At this point the mixing tip 26 is joined with the beak 28 and this structural combination can be removed from the assembly device 10 for connection with the syringe body 24. A more detailed disclosure for this engagement is provided with reference to FIGS. 4 and 5.

In FIG. 4 it is shown that the beak 28 is formed with a lumen 48, and has a beveled grip 50 that is formed with a projection 52 as part of the gripping member 32. It is also shown that the gripping member 32 includes a ledge 54 which has an outer diameter Dₒ. Importantly, an annular recess 56 is established for the gripping member 32 between the ledge 54 and the projection 52 of the beveled grip 50. FIG. 5 shows that when the mixing tip 26 is engaged with the beak 28 (see FIG. 3), a grab ring 58 is seated in the annular recess 56 of the beak 28.

While the particular System and Method for Engaging Beaks and Mixing Tips as herein shown and disclosed in detail is fully capable of obtaining the objects and providing the advantages herein before stated, it is to be understood that it is merely illustrative of the presently preferred embodiments of the invention and that no limitations are intended to the details of construction or design herein shown other than as described in the appended claims.

What is claimed is:

1. A device for assembling a mixing syringe which comprises:
a top plate defining a perimeter and formed with a hole through the top plate having a diameter D, wherein the hole is positioned on the top plate at a distance from the perimeter; and
a support member engaged with the perimeter of the top plate to maintain the hole of the top plate at a predetermined height H above a surface when the support member is positioned on the surface, wherein a first component of the mixing syringe is positioned against the top plate with a first portion thereof inserted downwardly through the hole of the top plate and a second portion thereof extending upwardly and away from the top plate in a proximal direction for engagement with a second component of the mixing syringe.

2. The device of claim 1 wherein the first component of the mixing syringe is a beak having a proximal end and a distal end, wherein the beak comprises:
a tapered tube formed with a lumen through its length, wherein the tube has a decreasing outer diameter in the distal direction from a diameter d at the proximal end of the tube; and
a gripping member formed at the proximal end of the tube, wherein the gripping member includes, sequentially in a proximal direction from the proximal end of the tube, a ledge having an outer diameter Dₒ extending radially outwardly from the lumen of the tube, an annular recess formed between the ledge and a beveled grip on the gripping member at the proximal end of the beak, wherein d of the beak's tube is less than D of the hole in the top plate, which is less than Dₒ of the ledge for inserting the tapered tube of the beak through the hole in the top plate to support the gripping member of the beak on the top plate with the gripping member extending upwardly and away from the top plate.

3. The device of claim 2 wherein the second component of the mixing syringe is a mixing tip which comprises:
an elongated tube surrounding a mixing chamber and having a proximal end and a distal end defining an axis therebetween;
a mixing screw positioned in the chamber of the tube;
a connector affixed to the proximal end of the tube for engaging the mixing tip with a mixing syringe; and
a circular grab ring formed at the distal end of the tube, wherein the grab ring extends radially inwardly toward the axis of the mixing chamber, and wherein the grab ring is dimensioned to be received into the annular recess of the gripping member to hold the tube of the mixing tip in fluid communication with the tapered tube of the beak when the mixing tube is engaged with the beak.

4. The device of claim 3 wherein the mixing syringe comprises:
a syringe body for holding a first cylinder containing a first material and a second cylinder containing a second material, wherein when the connector of the mixing tip is engaged with the syringe body, the first cylinder and the second cylinder are connected in fluid communication with the elongated tube of the mixing tip; and
a plunger mounted on the syringe body for simultaneously pushing the first and second materials respectively from the first and second cylinders and into the mixing chamber of the elongated tube for interaction with the mixing screw to combine the first and second materials into a composite material for extrusion from the mixing tip and through the beak.

5. The device of claim 4 wherein the composite material is used to make a dental impression.

6. The device of claim 4 wherein the composite material is used to make a plastic build-up.

7. The device of claim 4 wherein the beak is made of a semi-deformable elastomer.

8. The device of claim 4 wherein the mixing tube of the mixing tip is made of a relatively rigid elastomer when compared with the beak.

9. The device of claim 4 wherein the beak and mixing tip, in combination, are disposable after use.

10. A device for assembling a mixing syringe, wherein the mixing syringe includes a beak, a mixing tip and a syringe body, the device comprising:
a top plate defining a perimeter and formed with a hole through the top plate having a diameter D; and
a support member engaged with the perimeter of the top plate to maintain the hole of the top plate at a predetermined height H above a surface when the support member is placed on the surface with the hole of the top plate presented to receive a portion of the beak inserted downwardly therethrough, with another portion of the beak extending upwardly and away from the top plate for engagement between a gripping member of the beak and a grab ring of the mixing tip, wherein the combination of beak and mixing tip are subsequently engaged with the mixing syringe.

11. The device of claim 10 wherein the beak has a proximal end and a distal end and comprises a tapered tube, wherein the tube is curved and is formed with a lumen through its length, and wherein the tube has a decreasing outer diameter in the distal direction from a diameter d at the proximal end of the tube.

12. The device of claim 11 wherein the gripping member is formed at the proximal end of the tube and, sequentially in a proximal direction from the proximal end of the tube, comprises:
a ledge having an outer diameter Dₒ extending radially outwardly from the lumen of the tube; and
an annular recess formed between the ledge and a beveled grip on the gripping member at the proximal end of the beak, wherein d of the beak's tube is less than D of the hole in the top plate, which is less than Dₒ of the ledge for inserting the tapered tube of the beak through the hole in the top plate to support the gripping member of the beak on the top plate with the gripping member extending upwardly and away from the top plate.

13. The device of claim 12 wherein the mixing tip comprises:
an elongated tube surrounding a mixing chamber and having a proximal end and a distal end defining an axis therebetween;
a mixing screw positioned in the chamber of the tube;
a connector affixed to the proximal end of the tube for engaging the mixing tip with the mixing syringe; and
a circular grab ring formed at the distal end of the tube, wherein the grab ring extends radially inwardly toward the axis of the mixing chamber, and wherein the grab ring is dimensioned to be received into the annular recess of the gripping member of the beak to hold the tube of the mixing tip in fluid communication with the tapered tube of the beak when the mixing tube is engaged with the beak.

14. The device of claim 13 wherein the mixing syringe comprises:
a syringe body for holding a first cylinder containing a first material and a second cylinder containing a second material, wherein when the connector of the mixing tip is engaged with the syringe body, the first cylinder and the second cylinder are connected in fluid communication with the elongated tube of the mixing tip; and
a plunger mounted on the syringe body for simultaneously pushing the first and second materials respectively from the first and second cylinders and into the mixing chamber of the elongated tube for interaction with the mixing screw to combine the first and second materials into a composite material for extrusion from the mixing tip and through the beak.

15. The device of claim 14 wherein the composite material is used to make a dental impression.

16. The device of claim 14 wherein the composite material is used to make a plastic build-up.

17. The device of claim 14 wherein the beak and mixing tip, in combination, are disposable after use.

18. A method for assembling a mixing syringe which comprises the steps of:
providing a device, wherein the device includes a top plate defining a perimeter and formed with a hole through the top plate having a diameter D, and a support member engaged with the perimeter of the top plate to maintain the hole of the top plate at a predetermined height H above a surface when the support member is placed on the surface;
inserting a tube portion of a beak downwardly through the hole in the top plate with a gripping member of the beak extending upwardly and away from the top plate;
engaging the gripping member of the beak with a grab ring of a mixing tip by pushing the grab ring of the mixing tip into an annular recess in the gripping member of the beak; and
attaching the combination of beak and mixing tip to the mixing syringe.

19. The method of claim 18 wherein the tube portion of the beak has a proximal end and a distal end, wherein the tube is tapered and curved and is formed with a lumen through its length, and wherein the tube has a decreasing outer diameter in the distal direction from a diameter d at the proximal end of the tube.

20. The method of claim 19 wherein the gripping member is formed at the proximal end of the tube and, sequentially in a proximal direction from the proximal end of the tube includes a ledge having an outer diameter Dₒ extending radially outwardly from the lumen of the tube, with the annular recess formed between the ledge and a beveled grip on the gripping member at the proximal end of the beak, wherein d of the beak's tube is less than D of the hole in the top plate, which is less than Dₒ of the ledge for inserting the tapered tube of the beak through the hole in the top plate to support the gripping member of the beak on the top plate.
